(19) United States
(12) Patent Application Publication
(10) Pub. No.: US 2023/0384621 A1
(43) Pub. Date: Nov. 30, 2023

(54) EYEGLASSES FOR HOLDING VAPE DEVICE

(71) Applicant: THOMAS JASON BARLOW, BONITA SPRINGS, FL (US)

(72) Inventor: THOMAS JASON BARLOW, BONITA SPRINGS, FL (US)

(21) Appl. No.: 17/827,666

(22) Filed: May 28, 2022

(51) Int. Cl. G02C 11/00; G02C 5/14

(52) U.S. Cl. CPC G02C 11/10; G02C 5/146

(57) ABSTRACT

Eyeglasses can include a frame and first and second temples. A first temple can include a first temple cavity and a first temple conduit having an intake aperture in communication with the first temple cavity, and an exhaust aperture opening at a distal first temple end. The first temple cavity can be configured to receive and hold a vape device having an outlet port, such that the outlet port is aligned with the intake aperture and in communication with the first temple conduit.

### FIELD OF THE INVENTION

The present invention relates to eyeglasses and vape devices.

### BACKGROUND OF THE INVENTION

Eyeglasses are optical instruments generally having a frame configured to hold a pair of lenses for correcting defective vision and/or blocking light from reaching a wearer's eyes. Some eyeglasses are provided without lenses.

Vape devices are electronic devices used for inhaling a vaporized composition of matter that can contain nicotine and/or a flavoring.

### SUMMARY OF THE INVENTION

It is an object of the present invention to provide eyeglasses for holding a vape device.

It is another object of the present invention to provide eyeglasses for holding a vape device that provides functional utility.

According to an exemplary embodiment of the present invention, eyeglasses can include a frame having first and second lens supports, and first and second temples.

In an exemplary aspect, such a frame can include first and second lens supports, with each of the lens supports being configured to hold a lens.

Such a first temple can include a proximate first temple end connected to the frame, a distal first temple end extending away from the frame, a first temple cavity formed between the proximate and distal first temple ends, and a first temple conduit having an intake aperture in communication with the first temple cavity and an exhaust aperture opening at the distal first temple end.

Such a second temple can include a proximate second temple end connected to the frame, and a distal second temple end extending away from the frame.

Optionally, such a second temple can be configured similarly to or the same as such a first temple.

In an exemplary aspect, such a first temple cavity can be configured to receive and hold a vape device having an outlet port, such that the outlet port can be aligned with the intake aperture and in communication with the first temple conduit.

In another exemplary aspect, such a second temple can weigh more than such a first temple.

In a further exemplary aspect, such a first temple can include a key structure extending into the first temple cavity.

In another exemplary aspect, such eyeglasses can further include the vape device, which can optionally include a vape device cavity configured to receive the key structure.

### BRIEF DESCRIPTION OF THE DRAWINGS

FIG. 1 illustrates exemplary eyeglasses having first and second temples, with the first temple having a first temple cavity with an optional key structure.

FIG. 2 illustrates an exemplary first temple having a first temple conduit having intake and exhaust apertures.

FIG. 3 illustrates an exemplary first temple cavity with an optional key structure.

FIG. 4 illustrates an exemplary vape device complementarily shaped to a first temple cavity having an optional key structure.

### DETAILED DESCRIPTION

It should be noted that this disclosure includes a plurality of embodiments each having a plurality of elements and aspects, and such elements and aspects need not necessarily be interpreted as being conjunctively required by one or more embodiments of the present invention. In particular, all combinations of such elements and aspects can enable a separate embodiment of the present invention, which may be claimed with particularity in this or any future filed Patent Application. Moreover, such elements and aspects disclosed herein or apparent herefrom, whether expressly or implicitly, are to be construed strictly as illustrative and enabling, and not necessarily limiting. Therefore, it is expressly set forth that any elements and aspects, independently or in any combination of one of more thereof, are merely illustratively representative of one or more embodiments of the present invention and are not to be construed as necessary in a strict sense.

Further, to the extent the same element or aspect is defined differently anywhere within this disclosure, whether expressly or implicitly, the broader definition is to take absolute precedence, with the distinctions encompassed by the narrower definition to be strictly construed as optional.

Illustratively, perceived benefits of the present invention can include functional utility, whether expressly or implicitly stated herein, or apparent herefrom. However, it is expressly set forth that these benefits are not intended as exclusive. Therefore, any explicit, implicit, or apparent benefit from the disclosure herein is expressly deemed as applicable to the present invention.

According to the present invention, eyeglasses and/or a vape device can be formed from any one or more materials or combinations of materials, such as one or more of plastic, rubber, wood, metal, crystalline material, or any other man-made or naturally occurring material, for example and not in limitation, insofar as functionally consistent with the present invention. Further, such eyeglasses and/or vape device can be manufactured in any one or more functionally compatible manners, such as through molding, cutting, machining, extrusion, etc., for example and not in limitation.

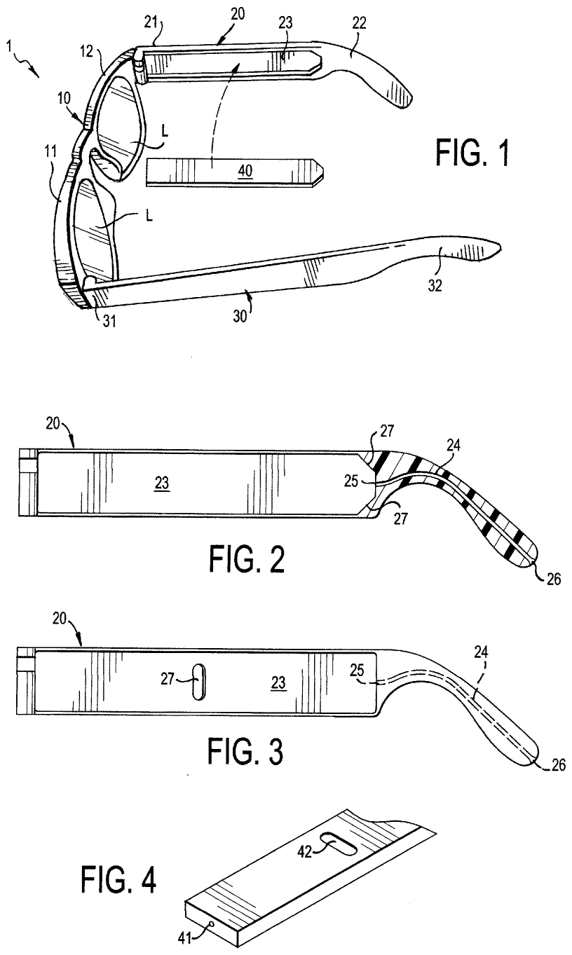

FIG. 1 illustrates an exemplary embodiment of the present invention, in which eyeglasses 1 can include a frame 10 having first and second lens supports 11, 12, with each of the lens supports being configured to hold an optional lens L; a first temple 20; and a second temple 30.

In an exemplary aspect, lens supports 11, 12 can be provided with any shape desired insofar as functionally compatible with the instant invention. Further, a holding function can be effectuated via a snap-fit, friction, an adhesive, a clasp, or any other manner and/or structure that can functionally holds lens L.

As further illustrated in FIG. 1, first temple 20 can include a proximate first temple end 21 connected to frame 10, a distal first temple end 22 extending away from the frame, a first temple cavity 23 formed between the proximate and distal first temple ends; and as illustrated in FIGS. 2 and 3, a first temple conduit 24 can include an intake aperture 25 in communication with the first temple cavity and an exhaust aperture 26 opening at the distal first temple end.

As additionally illustrated in FIG. 1, second temple 30 can include a proximate second temple end 31 connected to frame 10, and a distal second temple end 32 extending away from frame 10. Notably, second temple 30 can optionally be configured the same as, or similar to, first temple 20 insofar as desired.

In an exemplary aspect, first and second temple 20, 30 can be connected to frame 10 via any type of hinge, for example and not in limitation. Notably however, such connections can be effectuated via any alternative structure, including but not limited to, an integral connection, one or more magnets, a clasp, an adhesive, etc., insofar as functionally compatible with the instant invention.

In another exemplary aspect, first temple cavity 23 can be configured to receive and hold a vape device 40 having an outlet port 41 (as illustrated in FIG. 4), such that the outlet port is aligned with intake aperture 25 and in communication with first temple conduit 24. For example and not in limitation, such holding can be effectuated via a frictional fit, one or magnets, a clasp, a snap, adhesive, etc. Accordingly, in operation, a user drawing on, or inhaling from, exhaust aperture 26 can create a vacuum that reaches outlet port 41 via first temple conduit 24, so as to allow delivery of a vaporized composition of matter (not shown) from the outlet port to a user. It should be noted that vape device 40 can be shaped to be smaller than first temple cavity 23 or to be an exact fit, for example and not in limitation.

In another exemplary aspect, second temple 30 can be configured to weigh more than first temple 20, so as to weigh at least substantially the same as the first temple when holding vape device 40.

In another exemplary aspect, first temple 20 can include key structure 27, which can define, at least in part, first temple cavity 23. For example, as illustratively shown in FIG. 2, key structure 27 can require vape device 40 to be shaped complementarily to first temple cavity 23 (and at least in part, to the key structure). In another example, as illustrated in FIG. 3, key structure 27 can be provided as a protrusion that extends into, and defines a volume of, first temple cavity 23. Accordingly, such a protrusion can require vape device 40 to have an alternative or additional complementary shape-based feature to allow the vape device to fit within the first temple cavity, such as a vape device cavity 42, as illustrated in FIG. 4.

It will be apparent to one of ordinary skill in the art that the manner of making and using the claimed invention has been adequately disclosed in the above-written and attached description of the exemplary embodiments and aspects of the present invention.

It should be understood, however, that the invention is not necessarily limited to the specific embodiments, aspects, arrangement, and components shown and described above, but may be susceptible to numerous variations within the scope of the invention. For example, while the present invention has been described above with particular examples, it should be noted that any aperture, port, or conduit can be positioned anywhere within a temple and can be provided with any desired shape, insofar as the same is functionally compatible with the instant invention. Therefore, the specification and drawings are to be regarded in an illustrative and enabling, rather than a restrictive, sense.

Accordingly, it will be understood that the above description of the embodiments of the present invention are susceptible to various modifications, changes, and adaptations, and the same are intended to be comprehended within the meaning and range of equivalents apparent to one of ordinary skill in the art.

Therefore, I claim:

1. Eyeglasses, comprising:
a frame having first and second lens supports, each of the lens supports being configured to hold a lens;
a first temple having a proximate first temple end connected to said frame, a distal first temple end extending away from said frame, a first temple cavity formed between the proximate first temple end and distal first temple end, and a first temple conduit having an intake aperture in communication with the first temple cavity, and an exhaust aperture opening at the distal first temple end; and
a second temple having a proximate second temple end connected to said frame, and a distal second temple end extending away from said frame;
wherein the first temple cavity is configured to receive and hold a vape device having an outlet port, such that the outlet port is aligned with the intake aperture and in communication with the first temple conduit.

2. The eyeglasses of claim 1, wherein said second temple weighs more than said first temple.

3. The eyeglasses of claim 1, wherein said first temple includes a key structure that defines, at least in part, said first temple cavity.

4. Eyeglasses, comprising:
a frame having first and second lens supports, each of the lens supports being configured to hold a lens;
a first temple having a proximate first temple end connected to said frame, a distal first temple end extending away from said frame, a first temple cavity formed between the proximate first temple end and distal first temple end, and a first temple conduit having an intake aperture in communication with the first temple cavity, and an exhaust aperture opening at the distal first temple end;
a second temple having a proximate second temple end connected to said frame, and a distal second temple end extending away from said frame; and
a vape device having an outlet port;
wherein the first temple cavity is configured to receive and hold said vape device, such that the outlet port is aligned with the intake aperture and in communication with the first temple conduit.

5. The eyeglasses of claim 4, wherein said second temple weighs more than said first temple.

6. The eyeglasses of claim 4, wherein said first temple includes a key structure, that defines, at least in part, said first temple cavity.

7. The eyeglasses of claim 6, wherein said vape device includes a vape device cavity configured to receive the key structure.
